(19) United States
(12) Patent Application Publication
(10) Pub. No.: US 2006/0111603 A1
(43) Pub. Date: May 25, 2006

(54) Storage of hazardous materials

(76) Inventor: Adele Charmaine Shaw, Cheshire (GB)

Correspondence Address: MYERS BIGEL SIBLEY & SAJOVEC, PO BOX 37428, RALEIGH, NC, 27627, US

(21) Appl. No.: 10/519,869

(22) PCT Filed: Jul. 3, 2003
(86) PCT No.: PCT/GB03/02870

§ 371 Date: Dec. 21, 2005

(30) Foreign Application Priority Data
Jul. 3, 2002 (GB) 0215341.9

(51) Int. Cl. G21F 9/16

(52) U.S. Cl. 588/3

(57) ABSTRACT

A nuclear material is encapsulated by treating the material with an encapsulant that includes a cementitious material and curing the cementitious material. The nuclear material includes uranium metal, Magnox fuel elements, and/or fuel element debris.

### FIELD OF THE INVENTION

This invention relates to a method for the treatment and storage of hazardous materials by encapsulation. More specifically, it is concerned with the encapsulation in cementitious media of materials encountered in the nuclear industry, and has specific application to uranium and so-called Magnox fuel elements.

### BACKGROUND TO THE INVENTION

Encapsulation has proved to be an especially favoured method for the disposal of certain hazardous materials; specifically it provides a suitable means for the conversion of these materials into a stable and safe form, which allows for long-term storage and/or ultimate disposal. The technique can find particular application in the nuclear industry, where the highly toxic and radioactive nature of the materials involved, and the extended timescales over which the toxicity is maintained, are the principal considerations when devising safe disposal methods.

In co-pending GB patent application No. 0130593.7, the present applicant has disclosed the use of cementitious grouting materials for the encapsulation of fine particulate sized wastes and provided details of a method for the encapsulation of fine particulate materials which comprises treating these materials with at least one microfine hydraulic inorganic filler.

The use of cement based injection grouting in the construction industry is well known from the prior art. Thus, EP-A-412913 teaches the use of a Portland Cement based grout in the consolidation of concrete structures affected by fine cracks, providing a cost-effective means of infilling both superficial and deeper fissures and cavities in such structures, including such as buildings, bridges and dams. Similarly, ZA-A-9209810 is concerned with a pumpable, spreadable grouting composition incorporating a cementitious and/or pozzolanic or equivalent material, and its application in sealing fissures and cracks, back-filling, providing mass fills in civil and mining works, or lining tunnels.

Also disclosed in the prior art are hydraulic setting compositions comprising particles of Portland Cement together with fine particles of silica fume containing amorphous silica, which are the subject of EP-A-534385 and are used in the production of concrete, mortar or grout having improved fluidity, whilst GB-A-2187727 describes a rapid gelling, hydraulic cement composition which comprises an acrylic gelling agent, a fine filler and Portland Cement, this composition being thixotropic and finding particular application in the formation of bulk infills for underground mining, and in the filling of voids and cavities in construction or civil engineering. A composition which also is useful in general building and construction work, and as an insulating material comprises a particulate filler, cellulose fibres and a cementitious binder, and is disclosed in GB-A-2117753.

Whilst the majority of these compositions of the prior art have a requirement for the addition of water, EP-A-801124 is concerned with a dry mixture, used for fine soil injection grout preparation, the mixture comprising fillers which do not react with water, cement and deflocculant; on addition of water, an agglomerate-free fine grout is formed, and this is easily injected into fine soil.

Thus, the use of such grouting materials in—primarily—civil engineering is well known, and its use in treating fine particulate sized wastes in the nuclear industry is the subject of the above co-pending application. However, whilst attempts have previously been made to encapsulate broken Magnox fuel elements, the treatment of uranium metal and complete Magnox fuel elements involved in nuclear processing has always been reliant on reprocessing techniques, many of which are well known to those skilled in such technology. Nevertheless, there has long been a need for an alternative approach for dealing with such fuel materials, particularly for those cases where reprocessing is especially difficult or hazardous—or, on occasions, impossible.

The present inventors have now found that cured cementitious materials may advantageously be employed for the long term encapsulation of uranium and Magnox fuel elements, as well as fuel element debris, thereby providing a product which remains stable and monolithic for many hundreds of years. Hence, a treatment method is provided which affords much greater efficiency, convenience and safety in handling, and has a consequent beneficial effect both in terms of environmental considerations and cost, thereby satisfying a long felt need in the nuclear industry wherein the waste management of materials is receiving ever greater attention in the global drive to ensure ever higher safety standards.

### STATEMENTS OF INVENTION

Thus, according to the present invention there is provided a method for the encapsulation of a nuclear material which comprises treating the material with an encapsulant which comprises a cementitious material and curing said cementitious material.

Generally, the nuclear material comprises a nuclear fuel material such as uranium metal or Magnox fuel elements or fuel element debris. Alternatively, it may comprise, for example, fast reactor fuel, metal oxide fuel or mixed oxide fuel.

The cementitious material may typically comprise, for example, Portland Cement or a similar commercially available product.

One or more additional inorganic fillers may optionally be added to the cementitious material; suitable fillers include blast furnace slag, pulverised fuel ash, hydrated lime, finely divided silica, limestone flour and organic and inorganic fluidising agents.

The invention also provides a method for the storage of a nuclear material which comprises encapsulation of the material in a cured cementitious material.

### DESCRIPTION OF THE INVENTION

The method of the present invention is of particular value in the treatment of nuclear fuel materials. Such materials may be treated by this method in order to obtain a product which remains stable and monolithic for many hundreds of years, thereby offering a safe and convenient alternative means of handling other than nuclear fuel reprocessing.

There exists a considerable worldwide stock of such nuclear fuel materials which, whilst safely stored for the medium term, requires a suitable route for long term disposal. This accumulation of this material provides powerful evidence of the absence of any suitable method of treatment. However, the present method now offers a safe and convenient technique for their disposal which should provide considerable environmental benefits.

A particular example of the application of the method involves placing the nuclear material in an appropriate container and adding a suitable cementitious material. Elements of the nuclear material may either be arrayed in the container or mixed haphazardly. The cementitious material is then added and allowed to at least partially cure, and the container may then be capped or, alternatively sent directly for storage or final disposal. The capping process involves placing a cap of cement on top of the mixture of nuclear material and cementitious material in the container after this mixture has been allowed to partially cure; the procedure has proved to be especially valuable in ensuring the safe long term storage of the material, and it provides an additional benefit in the reduction of secondary waste.

The container may comprise any container of an appropriate form and size, for example a drum having a capacity in the region of 500 litres. In such a case, the amount of nuclear material which may safely be stored may be up to as many as 52 elements. Preferably, however, the number of elements would be of the order of 22.

Typically, the cementitious material is provided in the form of an aqueous composition with a water content preferably in the region of 40-50% (w/w). Thus, the material may conveniently be pumped under pressure into the container.

1. A method for the encapsulation of a nuclear material, comprising:
treating the nuclear material with an encapsulant which comprises a cementitious material; and
curing said cementitious material;
wherein said nuclear material comprises uranium metal, Magnox fuel elements, and/or fuel element debris.

2. (canceled)

3. A method as claimed in claim 1 wherein the cementitious material comprises Portland Cement.

4. A method as claimed in claim 1 wherein the cementitious material further comprises at least one inorganic filler, the at least one inorganic filler comprising blast furnace slag, pulverised fuel ash, hydrated lime, finely divided silica, limestone flour and/or organic and inorganic fluidising agents.

5. A method as claimed in claim 1 wherein the cementitious material is provided in the form of an aqueous composition.

6. A method as claimed in claim 5 wherein the water content of the composition is about 40-50% (w/w).

7. A method as claimed in claim 1 further comprising:
placing the nuclear material in a container before treating the nuclear material and curing the cementitious material.

8. A method as claimed in claim 7 wherein elements of the nuclear material are either arrayed in the container or mixed haphazardly.

9. A method as claimed in claim 7 further comprising:
capping the container after the cementitious material has at least partially cured.

10. A method as claimed in claim 7 wherein the container comprises a drum having a capacity of about 500 litres.

11. A method as claimed in claim 10 wherein an amount of nuclear material stored in the container is up to about 52 elements.

12. A method as claimed in claim 11 wherein the number of elements is about 22.

13. A method of storing a nuclear material comprising:
encapsulating the nuclear material in a cured cementitious material, wherein said nuclear material comprises uranium metal, Magnox fuel elements, and/or fuel element debris.
